(19) United States
(12) Patent Application Publication
(10) Pub. No.: US 2016/0301482 A1
(43) Pub. Date: Oct. 13, 2016

(54) SLEEVED GARMENT EQUIPPED FOR HUMAN BODY COMMUNICATION

(71) Applicant: Intel Corporation, Santa Clara, CA (US)

(72) Inventors: Anand S. Konanur, Sunnyvale, CA (US); Arsen Zoksimovski, Santa Clara, CA (US); Anchit Dixit, Santa Clara, CA (US); Patrick A. Buah, JR., Santa Clara, CA (US); Jaroslaw J. Sydir, San Jose, CA (US)

(21) Appl. No.: 14/583,697

(22) Filed: Dec. 27, 2014

(51) Int. Cl. H04B 13/00; H04W 4/00; H04B 1/3827

(52) U.S. Cl. CPC H04B 13/005; H04B 1/385; H04W 4/008; H04W 4/005

(57) ABSTRACT

A garment includes a passive human body communication (HBC) component that includes, for example, a storage element. The garment has conductive cuffs and a flexible conductive trace connecting the cuffs to the HBC component. When a user wearing the garment touches the electrodes of an HBC interface on an external host device, the host device powers the HBC component and may send or receive data from the HBC component. The power and the data travel over the user's body from the interface electrodes to the cuffs, and at least partially through the conductive trace from the cuffs to the HBC component.

### RELATED APPLICATIONS

None

### FEDERALLY SPONSORED RESEARCH AND DEVELOPMENT

None

### APPENDICES

None

### FIELD

Related fields include wearable electronics, human body communication (HBC), and more particularly passive wearable devices that draw power from other electronics during an interaction through an HBC link.

### BRIEF DESCRIPTION OF DRAWINGS

FIGS. 1A-C illustrate the structure and use of examples of sleeved garments with conductive cuffs.

FIGS. 2A-B are block diagrams of a wearable HBC storage device and a corresponding HBC interface on a host device.

FIG. 3 is a simplified electrical schematic of a wearable HBC storage device with an optional wearable sensor.

FIG. 4 is a simplified electrical schematic of the host interface for supplying power to the wearable HBC tag during a data-sharing interaction.

FIGS. 5A-D illustrate alternate two-cuff embodiments.

FIGS. 6A-D illustrate alternate single-cuff embodiments.

FIGS. 7A-B illustrate embodiments in which the conductive traces from two separate garments are joined to form a unified HBC assembly.

### DETAILED DESCRIPTION

Wearable electronic devices may include sensors, computational components, storage elements, and wireless communication components integrated into wearable articles such as clothing, watches, and eyeglasses. The wireless communication components tend to dominate the power requirements of wearable electronics assembly. Users are not accustomed to regularly charging their clothing, watches, or eyeglasses; therefore, as with other wireless communication devices, it is desirable for wearable electronics not to need frequent charging.

Moreover, if the wearable electronics market is to grow until wearable devices become ubiquitously integrated into a broad range of clothing and accessories, their cost must be reduced until users in the target market can own multiple wearable devices that they can use interchangeably that is, they do not need to change into a single “special” set of clothing or accessories whenever they want to use their wearable devices.

Often, wearable electronics are intended to collect data and share it with other “host” devices. This presents an opportunity to draw power from the host devices to operate the wearable electronics components, analogously to a passive RFID tag being powered by an external reading or writing device for as long as a reading or writing transaction continues. If the wearable electronics are passive when not connected to a host, the garment or other wearable article will never need to be charged. If a battery is included in the wearable article to enable at least some of the wearable electronics to operate when a host is not connected, the host can charge the battery every time the user exchanges data with the host. Because data exchange is the intended purpose of the wearable device, it is less likely to be neglected than an ancillary chore such as single-task battery recharging.

Therefore, users of wearable electronics would benefit from being able to draw a significant portion, and perhaps all, of their required electrical power from host devices during a data-exchanging interaction.

Human body communications (HBC) devices conduct signals and power over the body surface of the user. It could enable multiple wearable devices on the same user's body to communicate without incorporating wires and the garment. At times, long body-surface paths can be lossy.

Embodiments of an HBC component draw power from external host devices during data transfer interactions. The efficiency of power transfer is increased by shortening the body-surface path over which the power must travel and replacing the remaining path length between the host device and the HBC device with a flexible conductive trace, such as conductive fabric, ribbon, or yarn, to transmit the power with lower loss.

Any conductive trace material of suitable resistivity, size, flexibility, and durability may be used. Some examples include nylon fiber with a conductive metallic coating (e.g. gold, copper, aluminum); fabric, cord or tape with embedded conductive wire; conductive hook-and-loop tape (e.g., Velcro™); conductive thumb, metallic thread, or metallic tape; metal gauze, metal mesh, or metallized cloth; carbon-fiber thread, cord, tape, or fabric; or any other suitable material.

Both the HBC component and the host's HBC interface may use resonant tuning to adjust the power transfer. Optionally, one or more batteries may be coupled to the HBC component to store any excess power delivered by the host device but not consumed in the data transfer interaction.

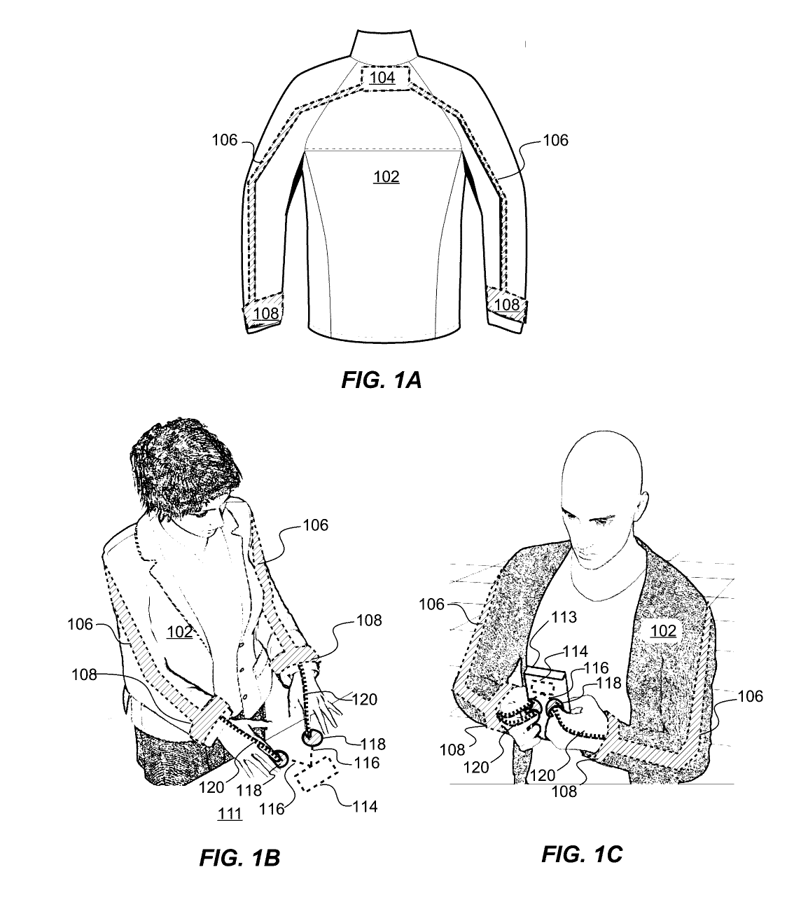

FIGS. 1A-C illustrate the structure and use of examples of sleeved garments with conductive cuffs. FIG. 1A shows the HBC component with conductive traces attached to a sleeved garment such as a shirt, sweater, or jacket. Garment 102 may be work gear such as a lab coat or factory coverall, activewear such as a warmup jacket or leotard, everyday business or casual clothing, a special-effects costume, or any other suitable type of garment. HBC component 104 is connected to conductive traces 106, which may be flexible. Traces 106 terminate in conductive loops or cuffs 108 at the wrists or forearms. HBC component 104, traces of 106, or conductive cuffs 108 may be invisibly integrated on the inside of the garment or integrated into an ornamental trim or design visible on the outside of the garment. Analogously, this approach may be embodied in slacks or tights with conductive traces down the legs and conductive cuffs around the ankles or shins.

This approach allows garment designers to be very flexible in positioning the HBC component. Unlike other systems such as near field communication (NFC), the component itself does not need to be brought very near to the host interface in order to exchange data. Therefore, the HBC component may be located in the neck, back, waist, or even a pocket of the garment, provided that the conductive traces lead from there to the conductive cuffs. The traces or cuffs may even have separable segments across parts of the garment that may open such as buttons or zippers, provided that the conductive connection can be made when the opening is closed (e.g., buttoned or zipped).

In addition, having a storage module built into a garment that the user is wearing removes the need for the user to keep track of the storage module in the form of a small, loose object that may easily be lost. If the wearable body-coupled network also includes one or more sensors of variables related to health or fitness, a garment offers a wide variety of placements for the sensors.

The assembly that includes the HBC component, conductive cuffs, conductive traces, and their connections may be integrated with the garment in numerous ways. The entire assembly may be permanently attached, with the traces and/or the cuffs sewn, knitted, woven, or fused with the fabric. The HBC component may be removable from and replaceable in the rest of the assembly, e.g., with snaps or a small plug in receptacle. In some embodiments where the HBC component is located in a pocket, the HBC component may be swapped by the user while wearing the garment. The entire assembly may be removable and replaceable; for example, attached to the garment with snaps or hook-and-loop tape. The cuffs and parts of the traces may even extend beyond the boundaries of the garment; for instance, a short-sleeved or sleeveless shirt may have the traces extend beyond the sleeves or arm holes to position the cuffs on the wrists or forearms. In some embodiments, the entire assembly may be worn independently of the garment and held onto the user's body with elastic elements or temporary adhesive, allowing the assembly to be used with any ordinary garment.

In FIG. 1B and FIG. 1C, users wear jackets with HBC assemblies and exchange data with host devices. In FIG. 1B, the host device is a computer or kiosk, while in FIG. 1C the host device is a mobile phone or tablet. The host communication chip 114 is connected by interior leads 116 to external touch pads 118. When the user touches pads 118, a circuit is completed that includes short body-surface paths 120 from touch pads 118 to conductive cuffs 108 as well as conventional conductive pounds for conductive cuffs 108 and traces 106 to the HBC component (mounted on the backs of the jackets, not visible in these views).

The HBC garments can share data with any compatible host device without requiring an Internet connection. Currently popular methods of stealing data, such as standing behind a person watching what they type, listening for different sounds made by different keys, or installing key-logging spyware will not work for data transfers from HBC garments. In addition, copying data from a source host device to the HBC storage element, then transferring the data to a destination host device, will allow the source and destination host devices to share data even if they cannot use a direct wireless connection (e.g., they are too far apart, intervening structures block the signal, or they are in an environment, such as an intensive care unit of a hospital, where wireless signals could interfere with the functions of important equipment.

In some embodiments, HBC interface electrode pads may be implemented on devices that are too small or thin for conventional connectors. Some embodiments may be able to operate while leaving the hands free; for example, stepping barefoot onto an HBC interface built into a doctor's scale, while wearing the HBC slacks, could allow doctors computer to collect exercise-related data from health-monitoring sensors (such as heart-rate sensors and step-counting accelerometers) that previously recorded their data into the HBC Storage element.

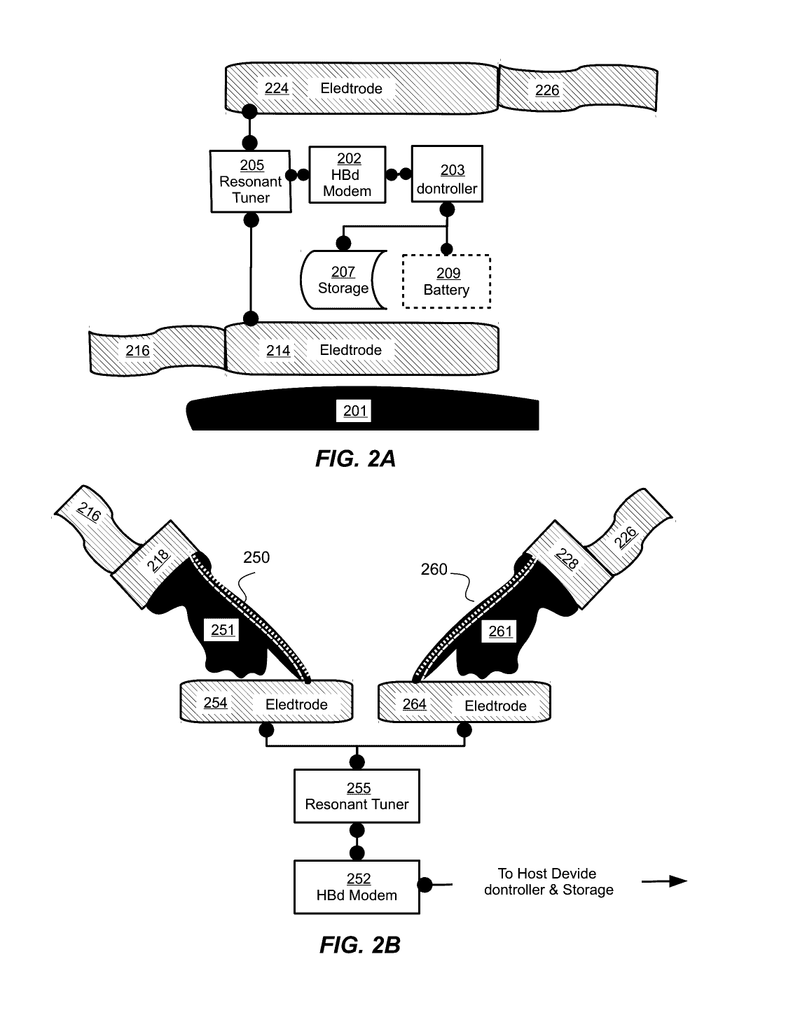

FIGS. 2A-B are block diagrams of a wearable HBC storage device and a corresponding HBC interface on a host device. FIG. 2A illustrates the HBC component or “tag”. Electrode 214 is in contact or near-contact with the user's body 201. One flexible conductive trace 216 is coupled to body-facing electrode 214. Electrode 224 faces outward from the user's body. Another flexible conductive trace 226 is connected to outward-facing electrode 224. A circuit that includes traces 216 and 226 will thus engage with the tag through its electrodes 214 and 224.

Electrodes 214 and 224 are connected by resonant tuning circuit 205, which tunes the tag for compatibility with the HBC interface of the host device. Data signals transmitted or received by the tag are processed by HBC modem 202. Controller 203 (e.g., a microcontroller) controls HBC modem 202, storage element 207, and optional battery 209.

A wearable electronics assembly functioning mainly for storage and transfer of data from host devices, or one with sensors that only need to operate in the presence of host devices, can draw all its needed power from the host device through the HBC interface while the user is interacting with the host device. If the wearable electronics assembly includes sensors that need to take readings when no host device is nearby, the sensors may be powered at such times by the optional battery 209. If present, battery 209 may be charged during data transfer is with host devices.

FIG. 2B illustrates the HBC interface on the host device. The HBC garment's conductive traces 216 and 226 terminate in conductive cuffs 218 and 228. Body-surface conductive paths 250 and 260 extend from conductive cuffs 218 and 228 to body extremities 251 and 261. The extremities touch interface electrode pads attached to the host device; extremity 251 touches interface electrode pad 254 and extremity 261 touches interface electrode pad 264. The “last few centimeters” of the connection between the tag and the host device are provided by the user's body.

In the illustration, the extremities 251 and 261 are fingertips. In some embodiments, the extremities contacting the interface electrode pads could be palms, knuckles, toes, or feet. Interface electrode pads 254 and 264 are connected to the host device's resonant tuner 255. The host device's resonant tuner 255 works with the tag's resonant tuner 205 (in FIG. 2A) to optimize the connection between the host and the tag by finding optimal frequency at which the conductivity of the user's skin is high and the high conductivity is insensitive to environmental noise. According to current knowledge in the field, the frequency range is likely to be between 1 MHz and 100 MHz. In some embodiments, the losses may be minimized when the tag is tuned to a frequency that is not equal to the host device's transmission frequency, but is close; for example, the host's transmission frequency may be fixed at 13.56 MHz, and the tag's lowest-loss frequency may be between 14 and 16 MHz. Other suitable frequency ranges for tags and host devices may be used within the scope of the described approach.

The frequency range passed by host-interface resonant tuner 255 is processed by a host-side HBC modem 252. In some embodiments, the interface may share one or more controllers and storage elements with other components of the host device. In other embodiments, the interface may have a dedicated microcontroller or dedicated storage.

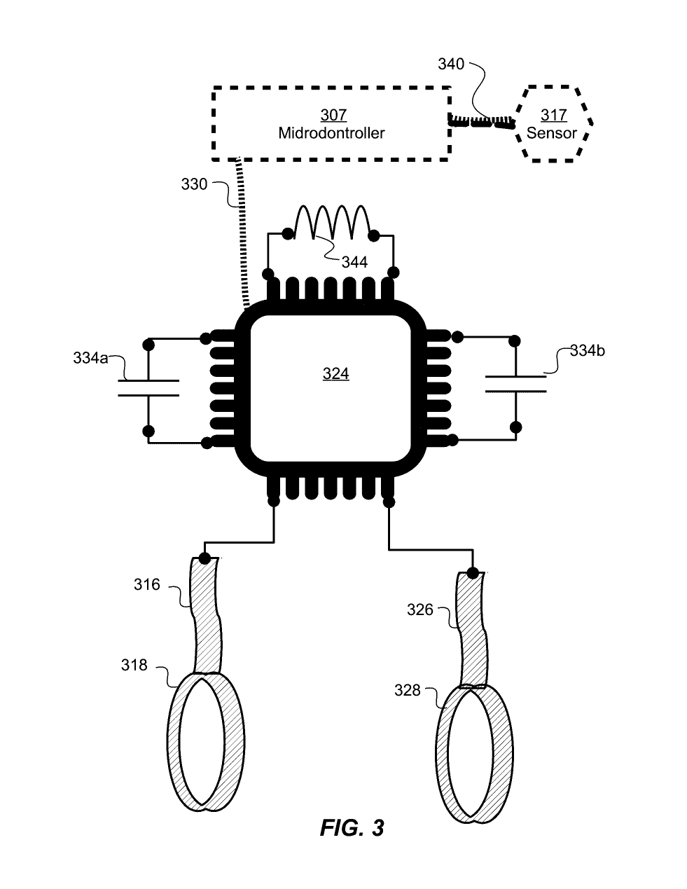

FIG. 3 is a simplified electrical schematic of a wearable HBC storage device with an optional wearable sensor. The HBC tag's communications chip 324 is connected to traces 316 and 326 leading to cuffs 318 and 328. The illustrated matching network includes two series capacitors 334a and 334b, and a shunt inductor 344. In some embodiments where the tuned frequency is 13-15 MHz, inductor 344 may have an inductance between 4.5 and 6.5 μH, and series capacitors 334a and 334b may each have a capacitance between 100 and 200 pF.

Some embodiments of HBC garments may include one or more microcontrollers 307 and/or sensors 317. Microcontroller 307 controls the operation of sensor 317 and processes the readings and receives from sensor 317. The tag's communications chip 324 may share data with microcontroller 307 over conductive path 330, which may be an HBC body-surface path or alternatively an additional conductive trace attached to the garment. Microcontroller 307 may exchange power and data 340 with sensor 317. Microcontroller 307 and sensor 317 may draw power from host devices during interactions between the assembly including the tag and an HBC interface of the host device. Alternatively, the HBC garment may include a built-in battery or other power source for microcontroller 307 and sensor 317.

In some embodiments, a data-sharing interaction between the tag and a host device may include copying or moving data collected by the sensors to the host for analysis and storage, followed by copying commands for the sensors and the tag from the host device to the tag and/or to one or more microcontrollers, other computational modules, or storage elements dedicated to particular sensors or groups of sensors. Meanwhile, power from the host device may be conveyed through the HBC interface to the tag and to the sensors and their support electronics to power the sensors and support electronics during the interaction, to charge any on-board batteries that enabled the sensors to operate between visits to host devices, or combination of both.

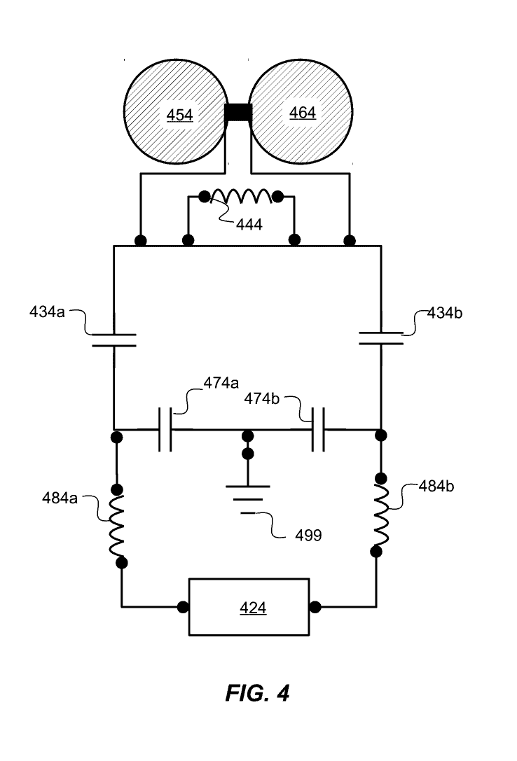

FIG. 4 is a simplified electrical schematic of the host interface for supplying power to the wearable HBC tag during a data-sharing interaction. For example, the user may connect the tag and to a transmission/interrogation chip on the host device by touching interface electrode pads 454 and 464. Interface electrode pads 454 and 464 are shunt-connected to the resonant tuning circuit.

The interface's matching network, similarly to the tag's matching network illustrated in FIG. 3, includes two series capacitors 434a and 434b as well as a shunt inductor 444. Inductor 444 primarily determines the system's resonant frequency, which is a function of the size, shape, materials, and environment of interface electrode pads 454 and 464. Capacitors 434a and 434b match the impedance provided by inductor 444 and interface electrode pads 454 and 464 to a value where transmitter/interrogator chip 424 is efficient; in some embodiments, the impedance is matched to a value that produces peak efficiency in transmitter/interrogator chip 424. For 13-15 MHz operation, inductor 444 may have an inductance between about 2 and 2.5 μH. Capacitors 434a and 434b may each have a capacitance between 100 and 200 pF. In some embodiments, capacitors 434a and 434b, inductor 444, or all three components may be variable, either accepting external input or self-tuning to find the optimal combination of frequency and impedance for communication with the HBC tag in the HBC garment.

The circuit also includes additional capacitors 474a and 474b, a ground connection 499, and additional inductors 484a and 484b connected to transmitter/interrogator chip 424. Capacitors 474a and 474b work with inductors 484a and 484b condition the shape of the signal from transmitter/interrogator chip 424 and eliminate high-frequency harmonics.

In some embodiments, the HBC garments are washable and/or dry cleanable. The HBC tag may be ruggedized and sealed, or alternatively may be disconnectable and reconnectable.

Health management offers many opportunities to make use of HBC garments. Readings from biological sensors can be collected between medical visits and transferred to the clinic's computer by a patient using an HBC interface in the doctor's office (or the waiting room). The clinics computer may analyze the data and make suggestions for prescriptions, lab tests, dietary changes, exercises, and the like, which the doctor may review from the viewpoint of his or her personal knowledge of the patient. Data may also be collected from wearable sleep-tracking systems and uploaded to a computer that summarizes the data and gives back suggestions on how to improve sleep, or even sound files of guided bedtime meditations or soothing music.

For patients with chronic pain, a collection of galvanic skin response (GSR) sensors may measure indicators of tension and circulation in various parts of the body. This GSR map may help a doctor or physical therapist find the ideal placements for heating, massage, or electrostatic stimulation.

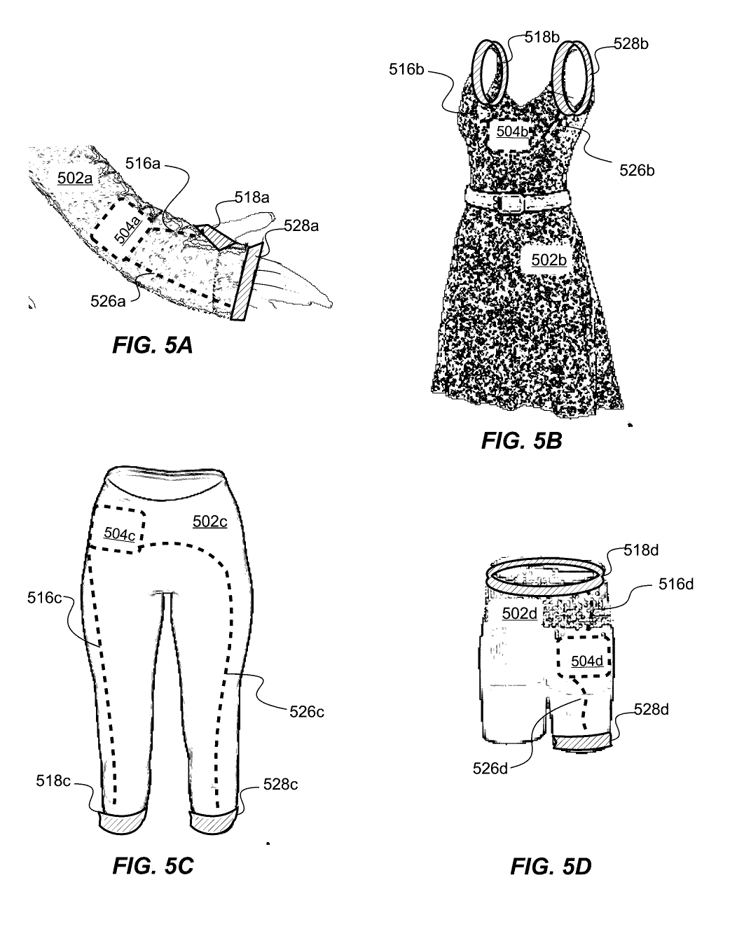

FIGS. 5A-D illustrate alternate two-cuff embodiments. In FIG. 5A, garment 502a is a blouse, shirt, or jacket with the “thumb-hole” sleeve. There is a first opening for the thumb and a second opening for the rest of the hand. This design allows for 2 separate encircling conductive cuffs 518a and 528a on the same hand; one around each of the openings. With this arrangement, HBC tag 504a can be further up the sleeve of garment 502a and the conductive traces 506a and 516a may optionally be made significantly shorter than embodiments where the conductive traces have to reach from the HBC tag to both of two wrists. To interact with the host device, the user touches one of the Interface electrode pads with the thumb and the other Interface electrode pad with one of the other fingers of the same hand.

In FIG. 5B, garment 502b is sleeveless. Instead of the illustrated sundress, sleeveless garment 502b could be a sleeveless shirt, swimsuit, undershirt, brassiere, or the like. Conductive cuffs 518b and 528b are located at the arm holes of sleeveless garment 504b. Conductive traces 516b and 528b connect the arm hold cuffs to the HBC tag and 504b, which is illustrated here as being attached near the upper chest of dress 502b, although alternatively it could be attached in the back. In some embodiments, these designs may be easy to use if the Interface electrode pads are not fixed in position but movable to different spacings and different orientations.

In FIG. 5C, garment 502c is a pair of slacks, pants, leggings, or tights. Conductive cuffs 518c and 528c encircle the user's legs at the ankles or shins. Traces 516c and 526c connect cuffs 518c and 528c to HBC tag 504c, which may be positioned in any suitable place outside or inside garment 502c. In some embodiments, garments with conductive cuffs terminating at the user's feet or legs may be used with an interface with interface electrode pads configured to make contact with the feet, toes, knees, or legs.

In FIG. 5D, garment 502d is a pair of shorts with one conductive cuff 518d integrated with the waistband and another conductive cuff 528d around the thigh. This placement allows HBC tag 504d and traces 516d and 528d to be located on the same side of the garment 502d. In some embodiments, not requiring the HBC assembly to cross the centerline of the garment may enhance comfort or durability during strenuous exercise. This example demonstrates that conductive cuffs need not be symmetrically placed; one may be around one type of limb or extremity, such as an arm or leg, and the other may be around another type of limb or extremity, such as the neck (e.g., in a collar), the face (e.g., in the edge or casing of a hood), or the torso (e.g., in a waistband or midriff band). Some these arrangements may also be used with alternative interface electrode pad configurations, such as widely spaced, angled toward each other, or mounted in standing or seating surfaces.

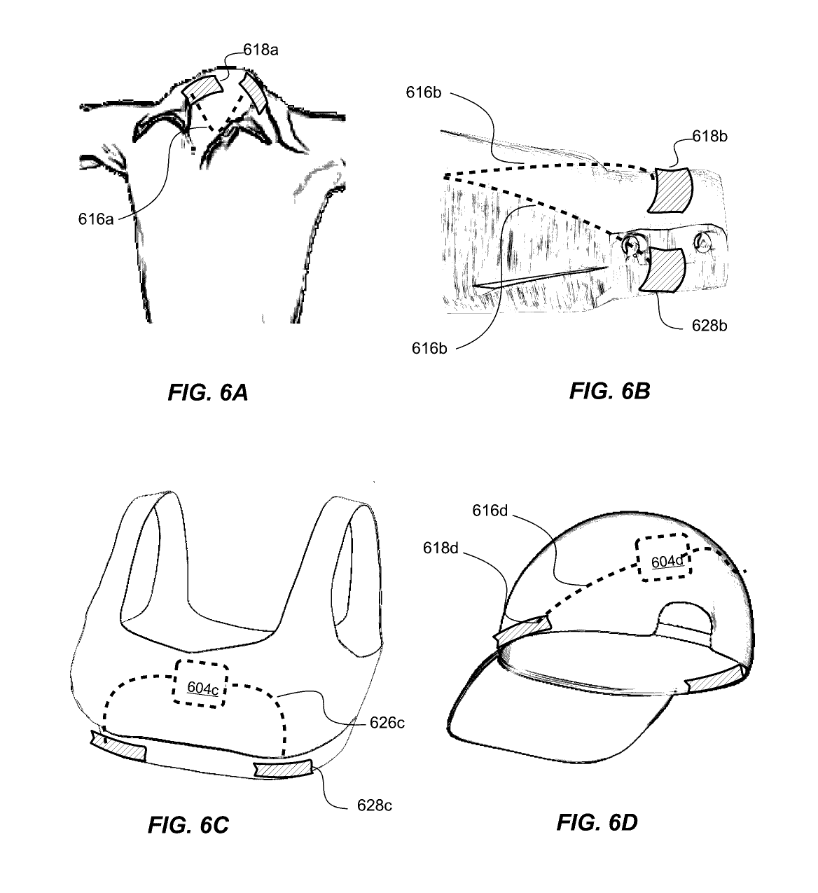

FIGS. 6A-D illustrate alternate single-cuff embodiments. In these examples, the transition from the conductive trace and garment to the HBC path on the skin to the interface electrode pads is not a pair of complete loops, but a pair of more generalized portions that can interface to different parts of the same body extremity. It is desirable in some designs to space these portions far enough apart that they will not form an HBC path from one to the other, shorting out the garment-borne part of the circuit. When the portions and traces are not constantly coupled to a garment-borne battery that continues operating when the garment is not interfacing to a host device, this will generally not be a problem.

In FIG. 6A, the pair of conductive portions, for example 618a, are inside a shirt collar. Conductive traces, for example 616a, connect the conductive portions to an HBC tag hidden in the back of the garment. To interface with the host device, getting the interface electrode pads fairly close to the conductive portions to shorten the HBC current path (which may be lossy) may be advantageous in some embodiments. Movable interface electrode pads that can be held against the size of the neck or the ears (in fact, the interface electrode pads might be incorporated into the inner surfaces of otherwise conventional headphones or ear buds, placed in close proximity to, e.g., less than 8 mm from, the skin of the ears).

In FIG. 6B, the two conductive portions 618b and 628b are separated along the perimeter of the shirt cuff, optionally on opposite sides of the buttoned slit where the fabric as a discontinuity. Conductive traces 616b and 626b have the option of being quite short (less than ˜10 cm long) if the HBC tag is attached that closely to the cuff-end of the sleeve, although longer traces and mounting of the HBC tag in the shirt back, shirt front, shirt tail, or shirt pocket are also compatible with this embodiment. As in the thumb-hole sleeve of FIG. 5A, both HBC path transitions are on the same hand. To interface with the host device, the user puts one or more fingers on one of the interface electrode pads and the remaining fingers on the other, or the thumb on one of the interface electrode pads and the fingers on the other. Either approach leaves the other hand free.

In FIG. 6C, the conductive portions, such as 628c, are attached to the midriff band of a short athletic top. HBC tag 604c is mounted near the upper sternum, and conductive traces, such as 626c, connect the HBC tag to the conductive portions. In some embodiments, using independently movable interface electrode pads on the host device can allow the user to adjust the HBC paths (e.g., on the torso) to low-loss lengths and positions.

In FIG. 6D, the conductive portions, said to 618 1D, are in separate positions on the perimeter of a hatband. HBC tag 604d is shown attached to the crown of the hat or cap, but alternatively it may be positioned on the bill or brim. Conductive traces such as 616d may either be hidden inside the cap or worked into an ornamental design on the outside. Possibilities for interfaces include independently movable interface electrode pads to be held against different parts of the neck, or alternatively fixed interface electrode pads built into a neck-rest, e.g. on the back of a chair.

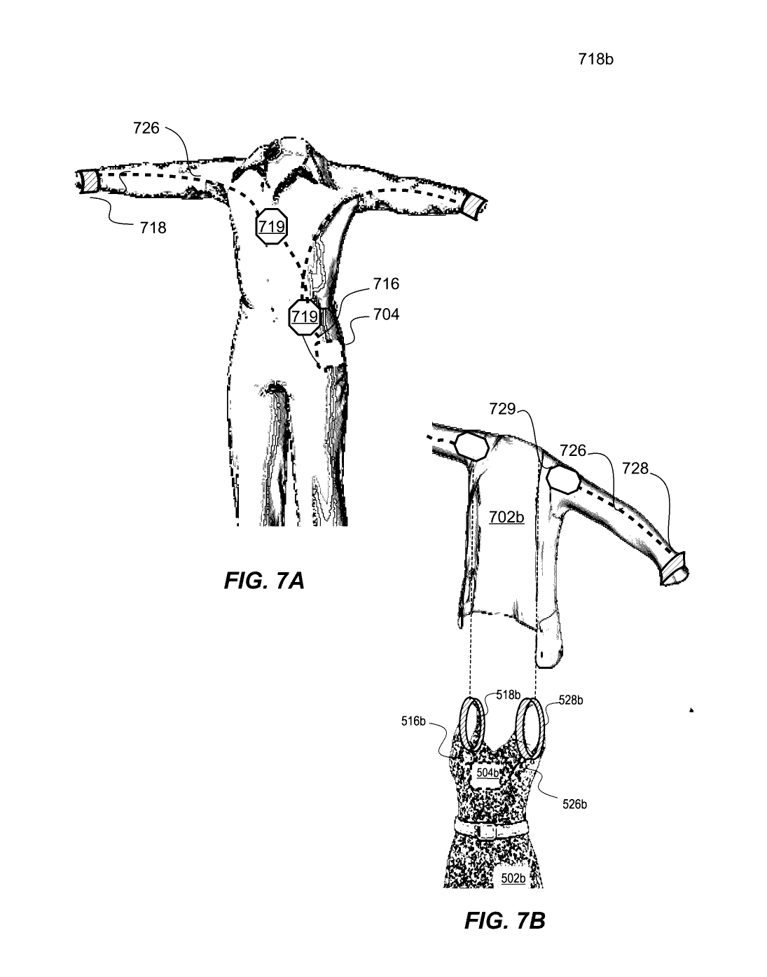

FIGS. 7A-B illustrate embodiments in which the conductive traces from two separate garments are joined to form a unified HBC assembly. In the previous examples, the entire garment-borne part of the circuit has been located on a single garment. However, given the availability of conductive snaps, conductive hook-and-loop tape, and other types of conductive connectors, splitting the garment-borne part of the circuit between two or more garments is feasible.

In FIG. 7A, the HBC tag or other module 704 is carried in a pants pocket. A first conductive trace 716 connects HBC tag 704 two conductive fastener 719 at the belt line of the pants. Conductive fastener 719 may make a conductive connection between the conductive trace terminating at the belt line of pants and a conductive trace continuing up the shirt. From there, the conductive traces may branch off to each of the two sleeves (or, if the conductive portions are like those in FIGS. 6A-D, to separate conductive portions at the end of one sleeve. Conductive connectors 719 can also be used to enable that raced across parts of the garment that are not permanently attached to each other (e.g., the 2 halves of the front of a button-front shirt).

In some embodiments, HBC tag 704, the first short trace, and half of the conductive connector 719 may not be permanently affixed to the pants; instead, HBC tag 704 may ride loosely in the pants (or may cling using cut-and-loop tape, a non-slip elastomer, or the like), and the pants half of conductive connector 719 may be temporarily clipped, pinned, or snapped to the belt or waistband of the pants. With this configuration, the same HBC tag 704 may be worn with multiple different pairs of pants on different occasions. The conductive components in the shirt may optionally include only conductive traces, conductive fasteners, and conductive portions. With no independent power, logic, memory, or other complex devices, the shirts may be inexpensive, rugged, and washable with normal laundry.

FIG. 7B is an exploded view of an extension for a body-coupled network that can be attached and detached by putting on or taking off an overgarment. As described in FIG. 5B, sleeveless dress 502b incorporated the HBC tag 504b and traces to conductive portions (configured as cuffs) 518b and 528b around the arm holes of dress 502b. In this illustration, sweater or jacket 702b has conductive fasteners 729 that line up with the conductive portions 518b and 528b of the dress. From the conductive fastener 729 on sweater 702b, a conductive trace 726 leads to conductive portion 728 at the wrist. Therefore, when the user wearing dress 502b puts on sweater 702, she can interact with the host device without taking the sweater off. Moreover, because sweater 702b has conductive portions terminating at the wrists, the user has much more flexibility as to the type of interface the host device may have; she does not need to use one that can position the interface electrode pads against her neck or torso to form a short, low-loss HBC path with conductive arm holes around the shoulders.

The preceding Description and accompanying Drawings describe examples of embodiments in some detail to aid understanding. However, the scope of the claims may also include equivalents, permutations, and combinations that are not explicitly described herein.

We claim:

1. A device, comprising:
a human body communication (HBC) component comprising a first electrode, a second electrode, a resonant tuning circuit, and a storage element;
a first conductive portion;
a second conductive portion;
a first conductive trace to couple the first conductive portion to the first electrode; and
a second conductive trace to couple the second conductive portion to the second electrode;
wherein the HBC component, the pair of conductive traces, and the pair of conductive portions are to be worn on a user's body;
wherein the first conductive portion contacts the user's body near a first extremity; and
wherein the second conductive portion contacts the user's body near a second extremity.

2. The device of claim 1, wherein at least one of the first conductive portion or the second conductive portion comprises a cuff.

3. The device of claim 1, wherein at least one of the first conductive trace, the first conductive portion, the second conductive trace, and the second conductive portion comprises a conductive fabric, a conductive thread, or a flexible conductive ribbon.

4. The device of claim 1, wherein the first conductive trace, the first conductive portion, the second conductive trace, and the second conductive portion are to be permanently integrated into a garment.

5. The device of claim 4, wherein the HBC component is to be disconnectable from, and reconnectable to, the first conductive trace and the second conductive trace.

6. The device of claim 4, wherein the HBC component is to be permanently attached to the garment.

7. The device of claim 1, wherein the HBC component, the first conductive trace, the first conductive portion, the second conductive trace, and the second conductive portion are to be detachably attached to a garment.

8. The device of claim 1, wherein the HBC component, the first conductive trace, the first conductive portion, the second conductive trace, and the second conductive portion are to be worn independently of a garment.

9. The device of claim 1, wherein the HBC component does not comprise a power source.

10. The device of claim 9, further comprising a battery coupled to the HBC component.

11. The device of claim 1, further comprising:
a microcontroller to be coupled to the HBC component; and
a sensor to be coupled to the microcontroller;
wherein readings of the sensor are to be collected by the microcontroller and stored in the storage element of the HBC component.

12. The device of claim 11, wherein the microcontroller and the sensor do not comprise a power source.

13. The device of claim 13, further comprising a battery to be coupled to at least one of the microcontroller or the sensor.

14. The device of claim 11, wherein the sensor comprises at least one of a microphone, a camera, a heart-rate sensor, a perspiration sensor, a galvanic skin response sensor, a temperature sensor, an accelerometer, or a sleep tracker.

15. The device of claim 1, wherein the HBC component comprises a resonance tuning circuit.

16. A system, comprising:
an HBC assembly comprising an HBC component, a first conductive portion, a second conductive portion, a first conductive trace coupling the first conductive portion to a first electrode of the HBC component, a second conductive trace coupling the second conductive portion to a second electrode of the HBC component; and
an HBC interface coupled to a host device, wherein the HBC interface comprises a first interface electrode pad, a second interface electrode pad, and a host communication module;
wherein a user is to complete a data-transfer circuit by wearing the HBC assembly, touching the first interface electrode pad with a first extremity extending from the first conductive portion, and simultaneously touching the second interface electrode pad with a second extremity extending from the second conductive portion;
wherein the circuit comprises a first body-surface conductive path between the first interface electrode pad and the first conductive portion and a second body-surface conductive path between the second interface electrode pad and the second conductive portion;
wherein the HBC component and the host device are to share data through the circuit; and
wherein the host device is to supply power to the HBC component through the circuit while the data is being shared.

17. The system of claim 16, wherein the host device comprises at least one of a general-purpose computer, a mobile computing device, a mobile communication device, or a kiosk.

18. The system of claim 16, wherein the HBC component comprises a first resonant tuning circuit and the HBC interface comprises a second resonant tuning circuit; and wherein the first resonant tuning circuit and the second resonant tuning circuit are to adjust the flow of power from the HBC interface to the HBC component.

19. A non-transitory machine-readable information storage medium containing code that, when executed, causes a machine to perform actions, the (code or actions) comprising:
to supply power to an HBC component from an external host device through a circuit; and
to exchange data with the HBC component through the circuit;
wherein the circuit comprises an HBC interface, a body surface of a user, a conductive portion, a conductive trace, and the HBC component; and
wherein the power is to be supplied and the data is to be exchanged in response to the user touching the HBC interface.

20. The non-transitory machine-readable information storage medium of claim 19, wherein the external host device comprises a general-purpose computer, a mobile computing device, a mobile communication device, or a kiosk.

21. The non-transitory machine-readable information storage medium of claim 19, additionally containing code that, when executed, causes a machine to perform further actions, the further actions comprising:
to adjust the power by operating a first resonant tuning circuit associated with the HBC interface and a second resident tuning circuit associated with the HBC component.
